(19) United States
(12) Patent Application Publication
(10) Pub. No.: US 2014/0360319 A1
(43) Pub. Date: Dec. 11, 2014

(54) HAND TOOL

(71) Applicant: Chin-Tan HUANG, Taichung City (TW)

(72) Inventor: Chin-Tan HUANG, Taichung City (TW)

(21) Appl. No.: 14/063,231

(22) Filed: Oct. 25, 2013

(30) Foreign Application Priority Data
Jun. 7, 2013 (TW) 102210755

(51) Int. Cl. B25G 1/04; B25B 23/16; B25B 23/00; B25B 15/02

(52) U.S. Cl. CPC B25G 1/043; B25B 15/02; B25B 23/16; B25B 23/0021; B25B 23/0035
USPC 81/177.2

(57) ABSTRACT

A hand tool includes a tubular casing, a tubular member connected to the tubular casing, a rod body extending through the tubular member into the tubular casing, two collar assemblies surrounded respectively by two oppositely-extending frustoconical urging surface portions of the tubular member and surrounding the rod body, and two resilient members biasing respectively the collar assemblies to abut against the rod body and abut respectively against the urging surface portions to thereby restrain the rod body from moving relative to the tubular casing. When the collar assemblies are moved to be released from the rod body and the urging surface portions, the rod body is permitted to move relative to the tubular casing.

### CROSS-REFERENCE TO RELATED APPLICATION

This application claims priority of Taiwanese Application No. 102210755, filed on Jun. 7, 2013.

### BACKGROUND OF THE INVENTION

1. Field of the Invention

The invention relates to a hand tool, more particularly to a telescopic hand tool.

2. Description of the Related Art

Taiwanese Utility Model Patent No. M240311 discloses a conventional telescopic screwdriver that includes a hollow handle, a shaft connected telescopically to the handle, and a positioning unit disposed in the handle for positioning the shaft relative to the handle. The handle has a frustoconical inner surrounding surface that has a large diameter end and a small diameter end. The positioning unit includes a ring member surrounded by the inner surrounding surface and surrounding and movable along the shaft, a plurality of balls embedded in the ring member and movable radially relative to the ring member, and a resilient member biasing resiliently the ring member toward the small diameter end of the inner surrounding surface of the handle such that the balls are in frictional contact with the shaft and the inner surrounding surface of the handle to thereby restrain the shaft from moving in a direction from the large diameter end to the small diameter end relative to the handle. The ring member has a diverging section diverging in the direction from the small diameter end to the large diameter end of the inner surrounding surface of the handle. The diverging section has a frustoconical outer surrounding surface. The positioning unit further includes a pair of angularly spaced-apart press members mounted in the handle and movable radially relative to the handle. Each of the press members has an urging end portion extending radially through the inner surrounding surface of the handle and tapering toward the shaft. The urging end portion of each of the press members is in slidable contact with the outer surrounding Surface of the diverging section of the ring member. When the press members are pressed radially and inwardly, the ring member is urged to more in the direction from the small diameter end to the large diameter end of the inner surrounding surface of the handle, such that the halls are moved from the small diameter end to the large diameter end of the inner surrounding surface of the handle, and are separated from the inner surrounding surface and released from the shaft to permit, the shaft to move relative to the handle.

However, the positioning unit of the conventional telescopic hand tool can only restrain the shaft from movement relative to the handle in the direction from the large diameter end to the small diameter end of the inner surrounding surface of the handle. Once the shaft is drawn in an opposite direction, the shaft may be loosen so as to be movable relative to the handle. Moreover, pressing the press members against the resilient force of the resilient member for moving the shaft relative to the handle is relatively laborious.

### SUMMARY OF THE INVENTION

Therefore, the object of the present invention is to provide a hand tool overcoming the aforesaid drawbacks.

Accordingly, a hand tool of the present invention includes a tubular casing, a rod body and a holding unit. The tubular casing extends along an axis, and has opposite first and second ends along the axis. The rod body extends along the axis, is connected telescopically to the tubular Casing, and has an enclosed end that is disposed in the tubular casing, and an exposed end that is opposite to the enclosed end along the axis and that extends out of the tubular casing via the second end of the tubular casing. The holding unit includes a tubular member, a pair of collar assemblies and a pair of resilient members. The tubular member extends along the axis, surrounds the rod body, and has a proximal end connected to the second end of the tubular casing and a distal end opposite to the proximal end along the axis and distal from the tubular casing. The tubular member has an inner surrounding surface that has two frustoconical urging surface portions diverging respectively in opposite diverging directions along the axis. The collar assemblies are surrounded respectively by the urging surface portions. Each of the collar assemblies includes a ring member that surrounds and that is movable along the rod body, and a plurality of angularly spaced-apart balls that are embedded in the ring member and that are radially movable relative to the ring member. The resilient members are disposed in the tubular member. Each of the resilient members biases a respective one of the collar assemblies oppositely of the diverging direction in which the respective one of the urging surface portions diverges such that the balls of the respective one of the collar assemblies are urged to be in frictional contact with the rod body and the respective one of the urging surface portions to thereby restrain the rod body from moving relative to the tubular casing oppositely of the diverging direction in which the respective one of the urging surface portions diverges. When each of the collar assemblies is moved in the diverging direction in which the respective one of the urging surface portions diverges against the biasing force of the respective one of the resilient members, the balls of the respective one of the collar assemblies are separated from the respective one of the urging surface portions and released from the rod body so that the rod body is permitted to move relative to the tubular casing along the axis.

### BRIEF DESCRIPTION OF THE DRAWINGS

Other features and advantages of the present invention will become apparent in the following, detailed description of the preferred embodiment with reference to the accompanying drawings, of which:

FIG. 1 is an exploded perspective view of a preferred embodiment of a hand tool according to the invention;

FIG. 2 is a fragmentary sectional view of the preferred embodiment, illustrating a rod body being restrained from moving relative to a tubular casing;

FIG. 3 is an enlarged fragmentary sectional view of the preferred embodiment;

FIG. 4 is a sectional view of the Preferred embodiment taken along line IV-IV in FIG. 2;

FIG. 5 is another fragmentary sectional view of the preferred embodiment, illustrating the rod body being permitted to move relative to the tubular casing; and

FIG. 6 is another sectional view of the preferred embodiment taken along line VI-VI in FIG. 5.

### DETAILED DESCRIPTION OF THE PREFERRED EMBODIMENT

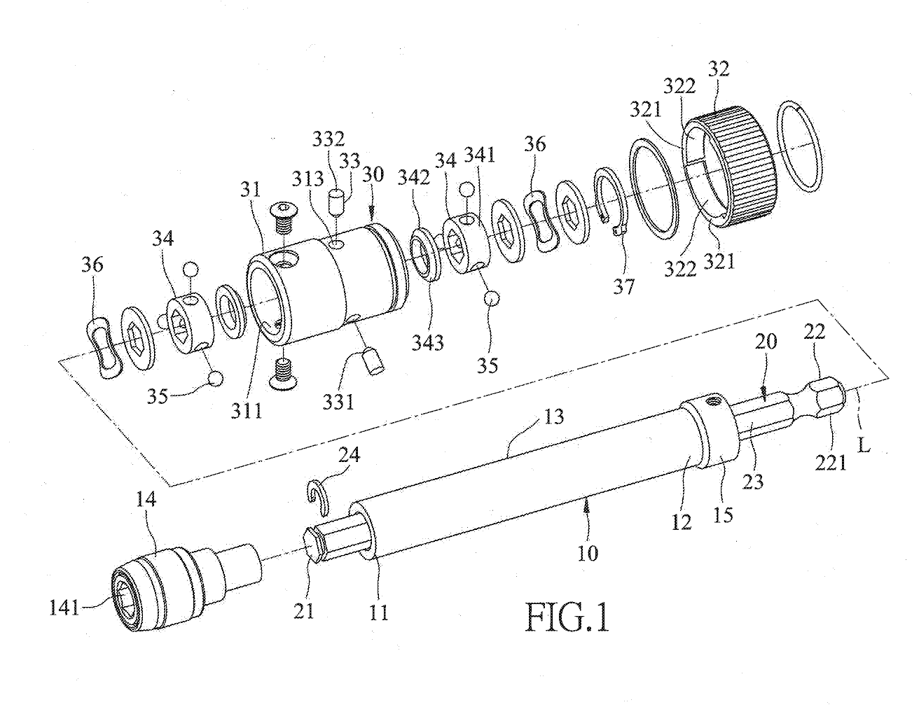

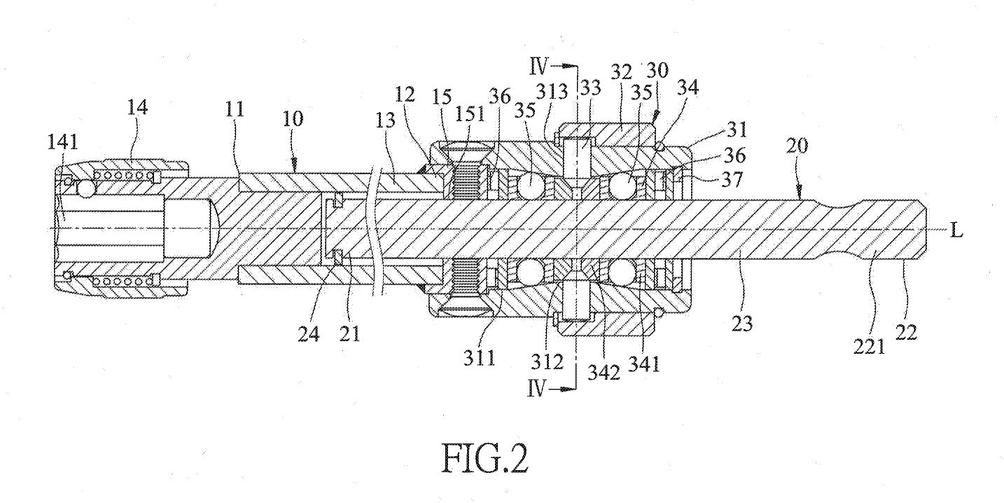

As shown in FIGS. 1 and 2, the preferred embodiment of a telescopic hand tool according to the present invention includes a handle 10, a shaft 20 and a holding unit 30.

The handle 10 includes a tubular casing 13, a first end piece 14 and a second end piece 15. The tubular casing 13 extends along an axis (L), and has opposite first and second ends 11, 12 along the axis (L). The first end piece 14 obstructs the first end 11 of the tubular casing 13, and is formed with a hexagonal hole 141 for installation of a screwdriver bit (not shown). The second end piece 15 is connected to the second end 12 of the tubular casing 13, and has a through hole 151 aligned and communicating with an inner space of the tubular casing 13. The through hole 151 has a diameter smaller than that of the inner space of the tubular casing 13.

The shaft 20 includes a rod body 23 that extends along the axis (L), and that is connected telescopically to the tubular casing 13 of the handle 10. The rod body 23 has an enclosed end 21 that is disposed in the tubular casing 13, and an exposed end 22 that is opposite to the enclosed end 21 along the axis (L) and that extends out of the handle 10 through the through hole 151 of the second end piece 15. The shaft 20 further includes an abutment member 24 that is mounted fixedly around the enclosed end 21 of the rod body 23 and that has a dimension greater than that of the through hole 151 to prevent the rod body 23 from separating from the handle 10 via the through hole 151. The exposed end 22 of the rod body 23 is formed with, for example, a hexagonal column 221 for installation of another screwdriver bit (not shown).

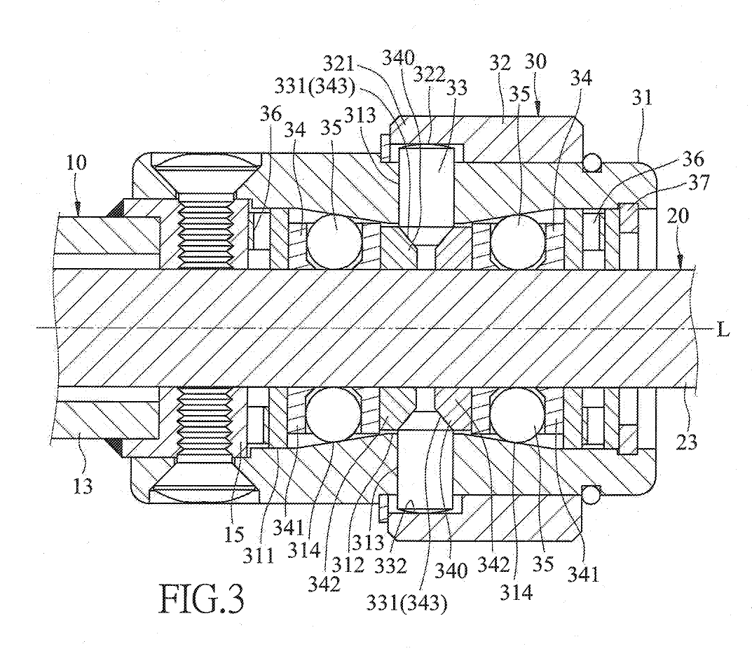

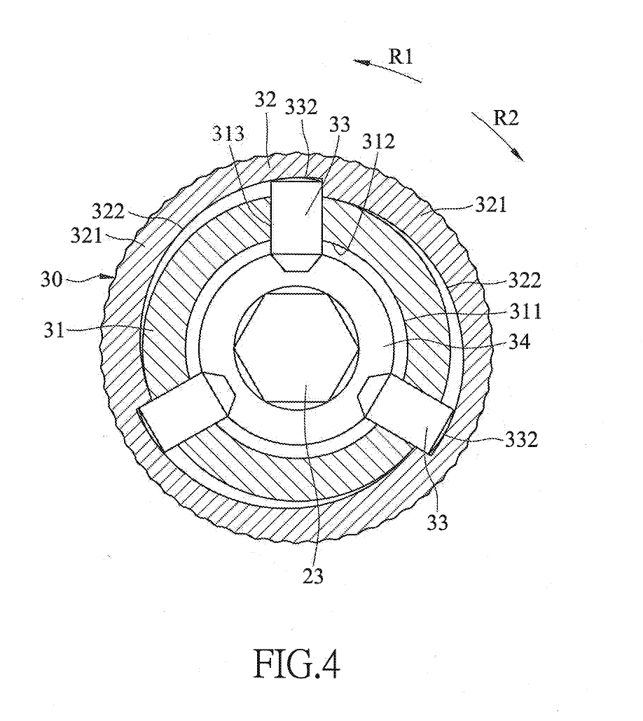

Referring to FIGS. 3 and 4, the holding unit 30 includes a tubular member 31, a sleeve member 32, a plurality of press members 33, a pair of collar assemblies, a pair of resilient members 36 and a restraint member 37.

The tubular member 31 extends along the axis (L), surrounds the rod body 23, and has a proximal end connected to the second end piece 15 of the handle 10 and a distal end opposite to the proximal end along the axis (L) and distal from the tubular casing 13. The tubular member 31 is connected to the second end piece 15 of the handle 10 by screws. The tubular member 31 has an inner surrounding surface 311 that has two frustoconical urging surface portions 314 diverging respectively in opposite diverging directions along the axis (L), and a central annular surface portion 312 interconnecting the urging surface portions 314. In this embodiment, the urging surface portions 314 of the inner surrounding surface 311 of the tubular member 31 diverge away from each other. The tubular member 31 further has a plurality of angularly spaced-apart installation holes 313 extending radially through the central annular surface portion 312 and an outer surrounding surface of the tubular member 31. The restraint member 37 is connected fixedly to the inner surrounding surface 311 adjacent to the distal end of the tubular member 31.

The collar assemblies are surrounded respectively by the urging surface portions 314 of the inner surrounding surface 311 of the tubular member 31. Each of the collar assemblies includes a ring member 34 that surrounds and that is movable along the rod body 23, and a plurality of angularly spaced-apart balls 35 that are embedded in the ring member 34 and that are radially movable relative to the ring member 34. The ring member 34 of each of the collar assemblies has a converging end portion 340 converging toward the ring member 34 of the other one of the collar assemblies. The converging end portion 340 of the ring member 34 of each of the collar assemblies has a frustoconical abutment surface 343. In this embodiment, for each of the collar assemblies, the ring member 34 has first and second ring pieces 341, 342 abutting against each other. The balls 35 are embedded in The first ring piece 341, and the converging end portion 340 is formed on the second ring piece 342.

The resilient members 36 are disposed in the tubular member 31. In this embodiment, each of the resilient members 36 is configured as a wave washer (which serves as a compression spring), and is sandwiched between one side of the ring member 34 of a respective one of the collar assemblies opposite to the converging end portion 343 of the ring member 34 along the axis (L) and the second end piece 15 or the restraint member 37 (i.e., each of the resilient member 36 is sandwiched between the first ring piece 341 of a respective one of the collar assemblies and a corresponding one of the second end piece 15 and the restraint member 37).

Each of the resilient members 36 biases the respective one of the collar assemblies oppositely of the diverging direction in which the respective one of the urging surface portions 314 diverges such that the balls 35 of the respective one of the collar assemblies are urged to be in frictional contact with the rod body 23 and the respective one of the urging surface portions 314 to thereby restrain the rod body 23 from moving relative to the handle 10 oppositely of the diverging direction in which the respective one of the urging surface portions 314 diverges. Since The urging surface portions 314 of the inner surrounding surface 311 of the tubular member 31 diverge away from each other (diverge in opposite directions) the rod body 23 is restrained from moving in opposite directions of the axis (L) relative to the handle 10.

The press members 33 engage respectively the installation holes 313, and are radially movable relative to the tubular member 31. Each of the press members 33 has a cylindrical pressing end portion 332 that extends out of the outer surrounding surface of the tubular member 31, and an abutting end portion 331 that is radially opposite to the pressing end portion 332, that converges toward the rod body 23, and that contacts slidably the abutment surfaces 343 of the ring members 34 of the collar assemblies.

When the press members 33 are moved radially toward the rod body 23, the collar assemblies are respectively urged to move away from each other along the axis (L) by the abutting end portions 331 of the press members 33.

The sleeve member 32 is sleeved rotatably on the tubular member 31 and surrounds the pressing end portions 332 of the press members 33. The sleeve member 32 has a plurality of circumferentially-arranged guiding sections 321. Each of the guiding sections 321 contacts slidably the pressing end portion 332 of a respective one of the press members 33 and has a radial thickness gradually increasing in a first circumferential direction (R1) (see FIG. 4). An inner surface 322 of each of the guiding sections 321 gradually converges toward the rod body 23 in the first circumferential direction (R1), such that, the press members 33 are urged radially toward the rod body 23 when the sleeve member 32 is rotated in a second circumferential direction (R2) (see FIG. 4) opposite to the first circumferential direction (R1).

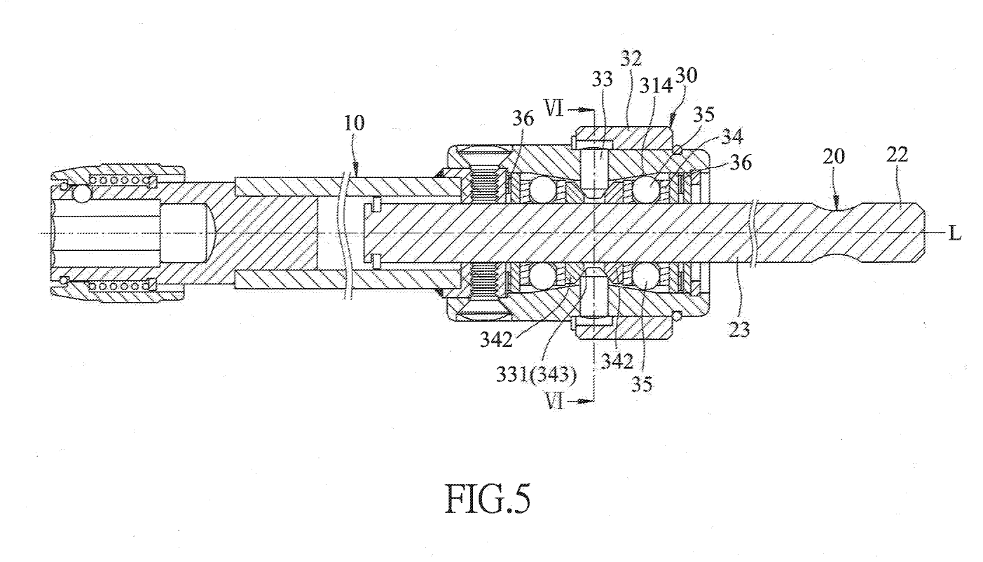

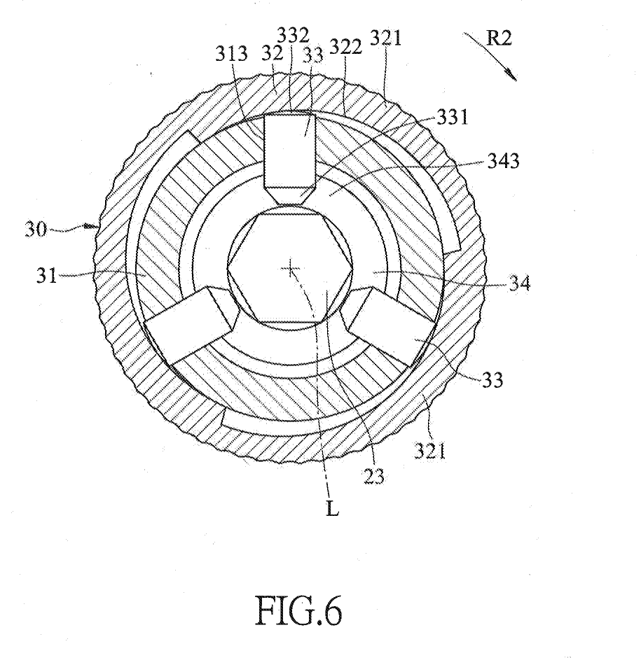

Initially, the rod body 23 is restrained from moving axially relative to the handle 10 by the holding unit 30, and each of the press members 33 contacts slidably a thinner portion of the respective one of the guiding sections 321 (see FIGS. 3 and 4). When the sleeve member 32 is rotated in the second circumferential direction (R2), as shown in FIGS. 5 and 6, the press members 33 are urged radially toward the rod body 23 to thereby urge the collar assemblies to move away from each other against the biasing force of the resilient members 36. Therefore, for each of the collar assemblies, the balls 35 are separated from the respective one of the urging surface portions 314 and released from the rod body 23 so that the rod body 23 is permitted to move relative td the handle 10 along the axis (L).

When the rod body 23 is moved relative to the handle 10 to a desired position, the sleeve member 32 is rotated in the first circumferential direction (R1) relative to the tubular member 31, such that the resilient members 36 respectively bias the collar assemblies to move toward each other, and that the press members 33 are kept to contact slidably and respectively the guiding sections 321 until the press members 33 contact respectively the thinner portions of the guiding sections 321. At this time, the balls 35 of the collar assemblies are once again in frictional contact with the rod body 23 to restrain the rod body 23 from moving in opposite directions of the axis (L) relative to the handle 10.

To sum up, the rod body 23 is restrained from moving in opposite directions of the axis (L) relative to the handle 10 by the holding unit 30 when the hand tool of this invention is in a normal state. In addition, the rod body 23 is permitted to move telescopically relative to the handle 10 by rotating the sleeve member 32 relative to the tubular member 31, which is more labor-saving than pressing the press members of the conventional telescopic hand tool disclosed in the prior art.

While the present invention has been described in connection with what is considered the most practical and preferred embodiment, it is understood that this invention is not limited to the disclosed embodiment but is intended to over various arrangements included within the spirit and scope of the broadest interpretation so as to encompass all such modifications and equivalent arrangements.

What is claimed is:

1. A hand tool comprising:
a tubular casing extending along an axis, and having opposite first and second ends along the axis;
a rod body extending along the axis, connected telescopically to said tubular casing, and having an enclosed end that is disposed in said tubular casing, and an exposed end that is opposite to said enclosed end along the axis and that extends out of said tubular casing via said second end of said tubular casing; and
a holding unit including
a tubular member that extends along the axis, that surrounds said rod body, and that has a proximal end connected to said second end of said tubular casino and a distal end opposite to said proximal end along the axis and distal from said tubular casing, said tubular member having an inner surrounding surface that has two frustoconical urging surface portions diverging respectively in opposite diverging directions along the axis,
a pair of collar assemblies that are surrounded respectively by said urging surface portions, each of said collar assemblies including a ring member that surrounds and that is movable along said rod body, and a plurality of angularly spaced-apart balls that are embedded in said ring member and that are radially movable relative to said ring member, and
a pair of resilient members that are disposed in said tubular member, each of said resilient members biasing a respective one of said collar assemblies oppositely of the diverging direction in which the respective one of said urging surface portions diverges such that said balls of the respective one of said collar assemblies are urged so be in frictional contact with said rod body and the respective one of said urging surface portions to thereby restrain said rod body from moving relative to said tubular casing oppositely of the diverging direction in which the respective one of said urging surface portions diverges;
wherein, when each of said collar assemblies is moved in the diverging direction in which the respective one of said urging surface portions diverges against the biasing force of the respective one of said resilient members, said balls of the respective one of said collar assemblies are separated from the respective one of said urging surface portions and released from said rod body so that said rod body is permitted to move relative to said tubular casing along the axis.

2. The hand tool as claimed in claim 1, wherein said urging surface portions of said inner surrounding surface of said tubular member diverge away from each other.

3. The hand tool as claimed in claim 2, wherein
said inner surrounding surface further has a central annular surface portion interconnecting said urging surface portions;
said tubular member further has a plurality of angularly spaced-apart installation holes extending radially through said central annular surface portion and an outer surrounding, surface of said tubular member;
said ring member of each of said collar assemblies has a converging end portion converging toward said ring member of the other one of said collar assemblies, said converging end portion of said ring member of each of said collar assemblies having a frustoconical abutment surface; and
said holding unit further includes a plurality of press members engaging respectively said installation holes and movable radially relative to said tubular member, each of said press members having a pressing end portion that extends out of said outer surrounding surface of said tubular member, and an abutting end portion that is radially opposite to said pressing end portion, that converges toward said rod body, and that contacts slidably said abutment surfaces of said collar assemblies, said collar assemblies being respectively urged to move away from each other along the axis by said abutting end portions of said press members to thereby permit axial movement of said rod body relative to said tubular casing when said press members are moved radially toward said rod body.

4. The hand tool as claimed in claim 3, wherein said holding unit further includes a sleeve member sleeved rotatably on said tubular member and surrounding said pressing end portions of said press members, said sleeve member having a plurality of circumferentially-arranged guiding sections, each of which contacts slidably said pressing end portion of a respective one of said press members and has a radial thickness gradually increasing in a first circumferential direction, an inner surface of each of said guiding sections gradually converging toward said rod body in the first circumferential direction such that said press members are urged radially toward said rod body when said sleeve member is rotated in a second circumferential direction opposite to the first circumferential direction.

5. The hand tool as claimed in claim 4, wherein each of said resilient, members is configured as a compression spring, and is disposed at one side of said ring member of the respective one of said collar assemblies opposite to said converging end portion of said ring member along the axis.

6. The hand tool as claimed in claim 5, wherein each of said resilient members is configured as a wave washer.

7. The hand tool as claimed in claim 3, wherein, for each of said collar assemblies, said ring member has first and second ring pieces abutting against each other, said balls being embedded in said first ring piece, said converging end portion being formed on said second ring piece.
